(19) United States
(12) Patent Application Publication
(10) Pub. No.: US 2012/0049679 A1
(43) Pub. Date: Mar. 1, 2012

(54) ELECTRIC MOTORS AND GENERATORS WITH OPPOSING NON-CONTACT PIEZOELECTRIC BEARING SUPPORTS

(75) Inventors: Serhiy Petrenko, Kiev (UA); Valentin R. Zhelyaskov, Sarasota, FL (US)

(73) Assignee: DISCOVERY TECHNOLOGY INTERNATIONAL, INC., SARASOTA, FL (US)

(21) Appl. No.: 13/222,866

(22) Filed: Aug. 31, 2011

Related U.S. Application Data
(60) Provisional application No. 61/378,703, filed on Aug. 31, 2010.

(51) Int. Cl. H02K 7/08; F16C 32/06

(52) U.S. Cl. 310/90; 384/1

(57) ABSTRACT

Electric motors and generators, in which a non-contact ultrasonic suspension of the rotor of the electric motor, are provided. The non-contact ultrasonic suspension is achieved by the formation of an elevated-pressure gaseous microfilm between conjugated surfaces of saddle-resonators and trunnions of a bearing system.

### CROSS-REFERENCE TO RELATED APPLICATIONS

This application claims the benefit under 35 U.S.C. §119(e) of U.S. Provisional Application No. 61/378,703, filed Aug. 31, 2010, the contents of which are incorporated by reference herein in their entirety.

### BACKGROUND OF THE INVENTION

1. Statement of Technical Field

The invention relates to the field of electric motors, generators, and other devices having rotating components suspended from non-contact bearings.

2. Description Of Related Art

Brushless motors operating on direct or alternating current are well known in the art. Such motors typically comprise a brushless acceleration unit, which includes a stator and a rotor, and an axial system. In the conventional synchronous or asynchronous brushless motors, the stator windings generate a rotating electromagnetic field. The rotating electromagnetic field interacts with the electromagnetic field of the rotor windings or with the permanent magnet field of the rotor, which creates a torque on the motor rotor. The rotor is installed on an axis which is fixed by bearings. Usually these are plain or rolling-element bearings.

Some brushless electric motors operate on the principle of non-contact support. For example, various electrostatic, magnetic, and superconducting contactless suspensions/supports have been suggested. See for example, Maleev, P. I., New types of gyroscopes. Leningrad: Sudostroenie, 1971, pages 9, 31. The operating principle of these devices resides in creating forces of either electrostatic or magnetic repulsion between a saddle-resonator and a corresponding trunnion.

A shortcoming of motors incorporating various electrostatic, magnetic, and superconducting contactless suspensions/supports is the significant technological difficulty involved in their implementation. This has contributed to relatively poor technical specifications and performance for motors of this type. For example, such motors tend to have relatively low load-bearing capacity, produce adverse torques, and involve complicated stabilization in space on account of considerable gaps and so on. The technological difficulties associated with such motors has also resulted in devices which have relatively high cost. Accordingly, motors incorporating these principles have failed to find broad application in commercial practice.

There are also known in the art various devices based on the formation of three-axis contactless ultrasonic supports. Such devices are discussed for example in Ukraine Patent No. 4169 to Petrenko, et al. which concerns a design for a gas-bearing precision instruments, and in USSR Patent No. 1782316 to Petrenko, et al. for a reliance precision instrument. However, these references are generally limited to various generic supports as opposed to motors arrangements.

Also known in the art are non-contact support systems that involve a gas support or bearing employed in a gas-dynamic gyroscope. See, e.g. Proceedings of the VII St-Petersburg International Conference on Integrated Navigation Systems, St. Petersburg, 2000, pp. 106-110. These systems are based on the idea of creating a gas micro-film of elevated pressure between the adjoining or conjugate surfaces of the saddle-resonator and of the trunnion. The elevated pressure area in this method is created owing to the dynamic characteristics of the gas stream formed in the gap between the adjoining surfaces of a gas turbine (saddle)—trunnion assembly.

Among the disadvantages of the gas support systems are significant technological complications related to the formation of a gas stream with the required dynamic parameters. For example, the requisite gas stream formation involves the complex configuration of the gap between the adjoining surfaces, the turbine design, and the requirement for highly stable turbine rotation. Other problems with the gas stream approach include: the inability to use that method in static mode, such as when the turbine/trunnion are immobile); the high energy demand (specifically when the system goes from static condition to movement); the inadequate three-axis stability of the support due to the considerable gap between the adjoining surfaces (as large as 1 mm for some designs) and fluctuation of the gas stream; significant gas-dynamic drag torques of such supports (as high as 10⁻³ g·cm); jerky motion; and the high cost of such supports/bearings. Moreover, gas supported motors are known to be difficult to stabilize, which in many cases requires significant and careful rotor balancing, especially when working at high rotation speeds. Specifically, the rotors in such systems need to be well balanced to avoid “beating” effect, which is characterized by jerky movement of the axis of rotation in various directions during the rotation. This happens when the center of mass does not coincide with the axis of rotation.

### SUMMARY OF THE INVENTION

The inventive concepts relate to economical motors and generators each with a fixed axis that uses ultrasound contactless support. Electric motors and generators with improved technical characteristics, namely decreased moment of friction force and power consumption, increased specific weight carrying ability, and increased spatial stability of the rotational axis, are provided.

The electric motor disclosed herein includes a rotor mounted on an axle. Upper and lower spherical trunnions are centered relative to the axle and attached to the axle. Each of the trunnions respectively engage a similar spherical (concave) surface formed from corresponding upper and lower annular saddles or saddle-resonators. The saddle-resonators and the trunnions are arranged such that there is only a minimal amount of axial play between the conjugated surfaces of the saddle-resonator and trunnion. For example, the axial play between the saddle-resonator and the trunnion can be within 1 to 40 μm. The saddle-resonators are centered with respect to the trunnions and are attached to a piezoelement. The piezoelement is secured within a motor housing which can also support the stator of the motor. The piezoelement is electrically connected to an excitation generator.

In the first three embodiments of the electric motor which shall be hereinafter described, the piezoelement is includes a planar annular piezoelement that is symmetrical with respect to the axle. The piezoelement has opposing end surfaces to which electrodes are attached for exciting the piezoelement. Further, the piezoelement is polarized in a direction normal to the planar end surfaces that carry the electrodes

In a first embodiment of the electric motor, the annular saddle-resonators are accommodated intermediate the trunnions, with the piezoelement being arranged intermediate the saddle-resonators. In this arrangement, the saddle-resonators engage the piezoelement along the opposite planar end surfaces of the piezoelement.

The stator and rotor in the first embodiment of the electric motor are arranged outside of the saddle-resonators and trunnions, with the piezoelement being mounted on the housing along its outer cylindrical surface. In this first embodiment, the housing is in the form of a cylindrical sleeve, with the respective piezoelement and stator being attached to the internal cylindrical surface of the housing.

In a second embodiment of the electric motor, the piezoelement is in the form of a combination of two symmetrically arranged piezoelements—the upper and lower ones, with the annular saddle-resonators being rigidly attached to the respective piezoelements.

In this embodiment, the upper saddle-resonator contacts the respective piezoelement along the upper end surface, and the lower saddle-resonator contacts the respective piezoelement along the lower end surface.

Further, the stator and the rotor are advantageously accommodated intermediate the upper and lower piezoelements.

In a third embodiment of the electric motor the trunnions are arranged intermediate the upper and lower saddle-resonators, with the upper saddle-resonator engaging the upper piezoelement along the lower planar end surface, and the lower saddle-resonator engaging the lower piezoelement along the upper planar end surface of the respective piezoelement, and the stator and rotor being accommodated intermediate the trunnions.

In a fourth, fifth and sixth embodiment of the electric motor which shall hereinafter be described, the piezoelement is in the form of an annular cylinder symmetrical with respect to the axis and radially polarized. The electrodes are applied onto the inner and outer cylindrical surfaces of the piezoelement. In the fourth embodiment of the electric motor, the annular saddle-resonators are accommodated intermediate the trunnions and are mounted on the piezoelement so that their cylindrical surfaces are attached to the inner cylindrical surface of the piezoelement. In this embodiment the stator and rotor are advantageously arranged outside of the saddle-resonators and trunnions.

In the fifth embodiment of the electric motor, the piezoelement is in the form of a combination of two symmetrically arranged annular cylinders—the upper and lower ones, with the annular saddle-resonators being rigidly attached to the respective piezoelements.

The annular saddle-resonators are accommodated intermediate the trunnions and mounted on the upper and lower cylindrical piezoelements. The outer cylindrical surfaces of the annular saddle-resonators are rigidly attached to the inner cylindrical surfaces of the respective piezoelements. In this embodiment of the motor, the stator and rotor are advantageously accommodated intermediate the upper and lower saddle-resonators.

In a sixth embodiment of the electric motor, the trunnions are accommodated intermediate the annular saddle-resonators. The saddle-resonators are mounted on the upper and lower cylindrical piezoelements so that their cylindrical surfaces are rigidly attached to the inner cylindrical surfaces of the respective piezoelements.

The stator and rotor are advantageously arranged intermediate the upper and lower trunnions.

In accordance with a further aspect of the inventive concepts disclosed herein, embodiments of electric motors and generators include a housing, a rotor, and a stator rigidly attached to the housing. The embodiments also include a first piezoelectric element rigidly attached to the housing, and a first saddle having a concave surface and rigidly attached to the first piezoelectric element. The embodiments further include a first trunnion rigidly attached to the rotor. The first trunnion has a concave surface that is a conjugate of the concave surface of the first saddle and is spaced apart from the concave surface of the first saddle by a gap. The first piezoelectric element, the first saddle, and the first trunnion form a bearing system configured to suspend the rotor for rotation in relation to the stator.

In accordance with a further aspect of the inventive concepts disclosed herein, embodiments of bearing systems for suspending a rotating component in relation to a non-rotating component include a first piezoelectric element rigidly attached to the non-rotating component and operative to undergo oscillatory deformation when subjected to an electric potential. The embodiments also include a first saddle having a concave surface and rigidly attached to the first piezoelectric element. The first saddle is operative to undergo oscillatory deformation in response to the oscillatory deformation of the first piezoelectric element, and the oscillatory deformation of the first saddle configured to generate a first field of acoustical energy in a gaseous medium adjacent to the concave surface. The embodiments further include a first trunnion rigidly attached to the rotating component. The first trunnion hays a concave surface that is a conjugate of the concave surface of the first saddle, and is spaced apart from the concave surface of the first saddle by the gaseous medium. The concave surface of the first trunnion is configured to be subjected to the first field of acoustical energy in response to the oscillatory deformation of the first saddle.

In accordance with a further aspect of the inventive concepts disclosed herein, a method for suspending a rotating component in relation to a non-rotating component includes providing a bearing system comprising a piezoelectric element rigidly attached to the non-rotating component; a saddle having a concave surface and rigidly attached to the piezoelectric element; and a trunnion rigidly attached to the rotating component. The trunnion has a surface that is a conjugate of the surface of the saddle and is spaced apart from the surface of the saddle by a gap. The method further includes applying a voltage potential to the piezoelectric element sufficient to excite the piezoelectric element so that the piezoelectric element induces oscillatory deformation in the saddle, the oscillatory deformation generates a field of acoustic energy in a gaseous medium within the gap, and the field of acoustic energy interacts with the conjugate surfaces of the trunnion and the saddle to produce a standing wave that supports the rotating component at least in part in relation to the non-rotating component.

Those skilled in the art will appreciate that while the present invention has been described in terms of a motor, the concepts and arrangements described herein can also be used to form electric generators. Accordingly, all such references to electric motors should also be understood to include electric generators.

### BRIEF DESCRIPTION OF THE DRAWINGS

Embodiments will be described with reference to the following drawing figures, in which like numerals represent like items throughout the figures, and in which:

FIG. 1 is a cross-sectional view of a first embodiment of an electric motor that is useful for understanding the inventive arrangements.

FIG. 2 is a cross-sectional view of a second embodiment of an electric motor that is useful for understanding the inventive arrangements.

FIG. 3 is a cross-sectional view of a third embodiment of an electric motor that is useful for understanding the inventive arrangements.

FIG. 4 is a cross-sectional view of a fourth embodiment of an electric motor that is useful for understanding the inventive arrangements.

FIG. 5 is a cross-sectional view of a fifth embodiment of an electric motor that is useful for understanding the inventive arrangements.

FIG. 6 is a cross-sectional view of a sixth embodiment of an electric motor that is useful for understanding the inventive arrangements.

### DETAILED DESCRIPTION

The invention is described with reference to the attached figures. The figures are not drawn to scale and they are provided merely to illustrate the instant invention. Several aspects of the invention are described below with reference to example applications for illustration. It should be understood that numerous specific details, relationships, and methods are set forth to provide a full understanding of the invention. One having ordinary skill in the relevant art, however, will readily recognize that the invention can be practiced without one or more of the specific details or with other methods. In other instances, well-known structures or operation are not shown in detail to avoid obscuring the invention.

The present invention concerns an electric motor in which a non-contact ultrasonic suspension of the rotor of the electric motor is provided. The non-contact ultrasonic suspension is achieved by the formation of an elevated-pressure gaseous microfilm between conjugated surfaces of a saddle-resonator and of a trunnion. Thus, the mechanical contact between the motor elements is completely eliminated. Consequently, friction is also substantially eliminated, except for friction associated with air or any other gas, and an unlimited service life can potentially be achieved. The elimination of mechanical contact also yields high smoothness of running and, consequently, substantial reduction of the level of rotational jerking motion. Damping of rotor oscillation provided by the resilience of the elevated-pressure gaseous microfilm provides a considerable decrease in the vibration and noise levels associated with the motor. The gaseous microfilm also allows the electric motor to accelerate to high speeds. Although the invention is generally described in terms of an electric motor, those skilled in the art will appreciate that it is not limited in this regard. For example, the inventive arrangements can be applied similarly to electric generators and other devices having rotating components suspended from non-contact bearings.

In each embodiment of the invention described herein, the formation of the ultrasonic contactless bearing support is achieved at each moment of time by means of a standing acoustic wave formed in the gaseous layer defined by the adjoining surfaces of the saddle-resonator and the trunnion. The resulting acoustic radiation pressure between the adjoining surfaces of the saddle-resonator and the trunnion is a function of the thickness of the gap therebetween. In the various embodiments of the invention, the gap is several microns to several dozens of microns, and simple calculations show that nonlinear acoustic effects are at work.

The nonlinear perturbation of pressure (Langevin acoustic radiation pressure), calculated at a given point on an ideal wall, is of the order of the square of the Mach number and it is given by the equation (1):

$$P = {ρ}_{0} {v}_{0}^{2} / {sin}^{2} ( \frac{ω}{c} {l}_{0} ) , \qquad ( 1 )$$

Where P is point pressure on the surface of the resonator;
ρ₀ is undisturbed gas density;
ν₀ is disturbance velocity;
c is the speed of sound in gas;
l₀ is the length of the acoustic resonator (the gap thickness);
ω is the cyclic frequency of disturbance (ω=ν·2π, where ν is frequency of disturbance).

From the foregoing equation it will be appreciated that as the value of l₀→0 the value of P→∞. This anticipated theoretical result has been found to correspond well to the experimental results.

The force acting on each point of the resonator equals dF=PdS, where dS is an element of the surface of the resonator (the conjugate or adjoining surface of the trunnion). As long as there is a complete symmetry of the acoustic resonator formed by the adjoining or conjugate surfaces of the saddle-resonator and of the trunnion (which is true in our case for the spherical resonator), the resulting vector F would be always directed along the axis of symmetry and will be determined from the relationship:

$$F = {\int }_{S} P d S = P {\int }_{S} n d S , \qquad ( 2 )$$

where n is the inner normal to the trunnion surface. Note that since F is a vector, the integral on the right side of the equation (2) has to be a vector too. It is a normal practice in physics to express dS as a product of the n (normal vector to the surface at that point) and dS (the elementary surface area). In this case the elementary surface area is the inner surface of the trunnion.

Estimates show that with an excitation frequency of 10⁴ to 10⁵ Hz and excitation power of about 10° to 10¹ W, the disturbance velocity created in the acoustic resonator owing to the resonant vibration of the saddle-resonator will be about 10⁻¹ . . . 10⁰ m/s. Therefore, for the gap thickness of l₀=30 μm, frequency ν=20 kHz, support area S=5 cm², disturbance velocity=1 m/s and at normal atmospheric pressure, the load-bearing capacity of the bearing support would be about 0.15 kg(f), which corresponds well to the experimental results. This load bearing capacity is calculated by using formula (I) to calculate the generated pressure P and then calculating the force F=P×S (S is the contact surface area between the trunnion and the saddle). The experimentally established magnitude of the gap thickness amounts to 0.5 to 20 μm which is equivalent to the initial axial play of the system (the double gap thickness) of 1 to 40 μm. As used herein, the term “axial play” refers to potential motion of the axis/bearing assembly in space due to mechanical tolerances in the bearing support. When axial play occurs, the axis is not aligned in one direction but can instead vary in position and alignment to some extent.

The process of non-contact ultrasonic rotor suspension utilized for the present invention is somewhat different from the ultrasonic levitation effect. The effect of ultrasonic levitation in the 20 to 200 kHz range takes place with gaseous layer thicknesses of several to tens of millimeters which is greater by over three orders of magnitudes than in the technical solution disclosed herein. Examples of the effect of ultrasonic levitation are described in Method and apparatus for acoustic levitation—U.S. Pat. No. 5,036,944—Filed Mar. 24, 1986; Cylindrical acoustic levitator/concentrator—U.S. Pat. No. 6,467,350—Filed Mar. 15, 2001; Levitated crystal resonator—U.S. Pat. No. 5,604,392—Filed May 12, 1995; Method for transferring levitated objects—U.S. Pat. No. 6,575,669 —Filed Oct. 17, 2001; Ultrasonic clutch—U.S. Pat. No. 6,964,327—Filed Dec. 11, 2002.

Indeed, the significant wavelength λ for this ultrasonic range in gas is 2=C/ν=1.5-15 mm, while the period of ultrasonic levitation will be defined as λ/2. In contrast, in our invention, effects of nonlinear acoustics of a higher order take place. This underlies the high precision capabilities of the inventive embodiments disclosed herein (axis stability in space with accuracy down to mere micrometers), which could not be attained with ultrasonic levitation.

In the embodiments disclosed herein, the piezoelement has the capacity of exciting therein longitudinal standing waves (radial mode of annulus ring oscillation) and a set of natural frequencies νₘ according to expression.

$${v}_{m} = \frac{1}{2 π} \sqrt{\frac{{E}_{p}}{{ρ}_{p} {R}_{p}^{2}} ( 1 + {m}^{2} ) ,} ( m = 0 , 1 , 2 , 3 … ) \qquad$$

where
E_{P}—Young's modulus of the piezoelement material;
R_{P}—middle radius of the piezoelement annulus;
ρₚ—specific weight of the piezoelement material.

The saddle-resonator is made with a capacity of exciting therein transverse flexural waves (with the annulus oscillation mode identical to “umbrella” vibrations) and a set of natural frequencies νₙ according to the following expression:

$${v}_{n} = \frac{1}{2 π} \sqrt{\frac{E}{{ρ}_{2} {R}^{2}} \frac{{I}_{x}}{{I}_{p}} ( 1 + {n}^{2} )} , ( n = 0 , 1 , 2 , 3 , )$$

where
E—Young's modulus of the saddle-resonator material;
R—middle radius of the saddle-resonator annulus;
Iₓ—moment of inertia of the section with respect to axis;
I_{P}—polar moment of inertia of the section;
ρ₂—specific weight of the saddle-resonator material.

In the presented embodiments the conjugated surfaces of the saddle-resonator and trunnion are shaped to form a gaseous acoustic resonator. With such an arrangement, the angle of incidence of the acoustic wave relative to the normal to the surface should be close to zero, and the wave reflection coefficient should be close to unity. Therefore, the saddle-resonator and the trunnion are made of an elastic material to satisfy the condition of required wave impedance, namely: ρ₀c [symbol] ρ₁c₁; ρ₀c [symbol] ρ₂c₂, where ρ₁c₁,ρ₂c₂ are the density and velocity of sound in the trunnion and saddle-resonator material, respectively; ρ₀c are the density and velocity of sound in the gas gap. These conditions are satisfied by glass. Hence, the saddle-resonators and trunnions are made of glass in the embodiments disclosed herein. The invention is not limited in this regard, and other materials can also be used provided that they satisfy the condition stated above with respect to the required wave impedance. The experimentally established degree of surface congruency and roughness of the conjugated surfaces on glass satisfy the conditions of 1 μm and 0.1 μm, respectively.

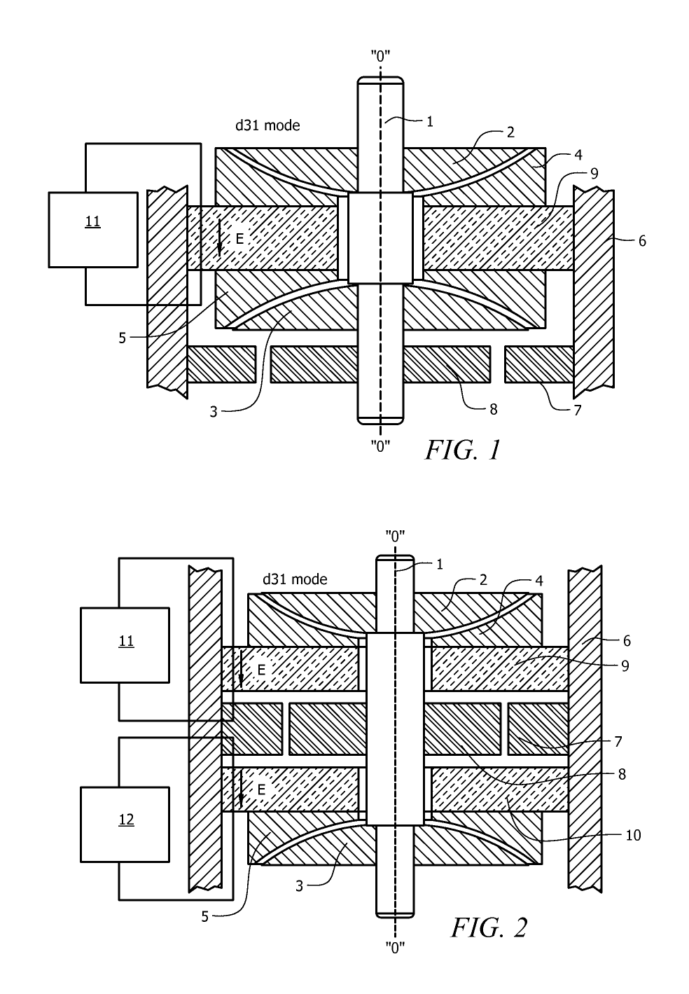

Referring now to FIG. 1, there is shown a first embodiment of the electric motor. The electric motor includes a rotor and a stator. The rotor includes an axle 1, upper and lower spherical trunnions 2, 3, and a rotor winding 8. The stator includes annular shaped upper and lower saddles or saddle-resonators 4, 5, a stator winding 7, and a piezoelectric element or piezoelement 9. The piezoelement 9 is excited by an excitation generator 11. The axle 1, upper and lower spherical trunnions 2, 3, upper and lower saddle-resonators 4, 5, stator 7, rotor 8, and piezoelement 9 can be contained within a motor housing 6 as shown.

The axle 1 is positioned symmetrically along a symmetry axis O-O (which is also referred to herein as a motor axis) on which the spherical upper trunnion 2 and lower trunnion 3 are centered and fastened. In this context, centering implies alignment of the center of the sphere (as defined by the curvature of the trunnion) with the axis of symmetry. The upper and lower spherical trunnions 2, 3 have spherical (convex) surfaces of substantially the same shape and dimensions as the spherical surfaces defined by the respective upper 4 and lower 5 annular saddle-resonators. The matching spherical surfaces of the upper trunnion 2 and the upper saddle-resonator 4, and the matching spherical surfaces of the trunnion 3 and the saddle-resonator 5 are referred to herein as conjugate surfaces.

In the embodiment shown in FIG. 1, the upper and lower saddle-resonators 4, 5 are situated intermediate the trunnions 2, 3. The saddle-resonators 4,5 are centered in a similar way with respect to the trunnions 2,3 (in respect to the axle 1) and are secured to the annular piezoelement 9 at the opposite end surfaces. The piezoelement 9 is polarized normally to the planar end surfaces, i.e. the polarization vector F is perpendicular to the end surfaces, and the electrodes of the piezoelement 9 are formed on these surfaces. The piezoelement 9 is secured on the housing 6 which also supports the stator winding 7, while the rotor winding 8 is mounted on the axle 1. With the foregoing arrangement, the axial play in the system is selected based on the required axial and radial rigidity and should be from several to tens of microns.

The electric motor illustrated in FIG. 1 operates as follows. An excitation voltage is supplied by the generator 11. The excitation voltage can be sinusoidal, at frequency νₙ⁰ corresponding to the zero-order mode of “umbrella” oscillation of the saddle-resonators 4, 5. The excitation voltage is fed to the piezoelement 9 where, due to the inverse piezoelectric effect, it produces a periodical in time deformation “extension—contraction” corresponding to the d₃₁ mode of oscillation. The d₃₁ mode of oscillation is well known in the art and therefore will not be described here in detail. However, it should be appreciated that with the d₃₁ mode of oscillation, the vector of primary radial oscillation of the piezoelement 9 is directed along the planar end surface of attachment of the saddle-resonators 4, 5 and the piezoelement 9, which causes periodic deformation of the piezoelement 9. Due to the rigid connection between the piezoelement 9 and the saddle-resonators 4, 5, this deformation is transferred to the saddle-resonators 4, 5. Consequently, a standing wave with strong bending deformation (due to the varying rigidity along the height of the resonator ring) is established in the saddle-resonators 4, 5, which causes “umbrella” type of oscillation. The standing wave causes the conjugated surface of each saddle-resonator 4, 5 to develop micro-angular oscillation. In particular, the conjugated surface of each saddle-resonator 4, 5, owing to interaction with the gaseous medium, commences to generate a directional acoustic field.

The directional acoustic field generated by each saddle-resonator 4, 5, is directed toward the conjugated surface of associated trunnion 2, 3, and toward its center of curvature of the conjugated surface. In other words, each saddle-resonator 4, 5 becomes a source of an acoustic field. This field is uniform and symmetrical over the entire surface of each saddle-resonator 4, 5, due to the inherently high geometric stability and symmetry of the support, the saddle-resonator surface manufacturing quality, and the high Q factor of each saddle-resonator 4, 5 (it has been established experimentally that Q=1,000-10,000). In this, the ultrasonic wave shape is defined by the shape of the spherical surface of each saddle-resonator 4, 5. The concave spherical surface of each saddle-resonator 4, 5, forms a directional acoustic field shaped as a spherical wave. While propagating in the gap between the conjugated surfaces of the trunnions 2, 3, and the saddle-resonators 4, 5, the wave is reflected by the similar convex surface of each trunnion 2, 3, and a standing spherical acoustic wave is formed in the gap, i.e. the gap begins functioning as a gaseous acoustic resonator. Consequently, the spherical surface of each trunnion 2, 3 (like the spherical surface of each saddle-resonator 4, 5) is acted upon by radiation acoustic pressure.

The axle system of this electric motor design in FIG. 1 is a self-aligning one. The thickness of the actual working gap, which is the same as the length of the acoustic resonator, is defined by compensation of the forces developed by radiation acoustic pressure from the two supports and the forces determined by the axial load-bearing capacity of the motor. In this way, ultrasonic suspension of the rotor of the electric motor is attained. A revolving magnetic field is formed at the stator winding 7, which, in interaction with the rotor winding 8, applies a rotary torque to the shaft of the electric motor.

As noted above, the piezoelement can be excited at frequency νₙ⁰ corresponding to the zero-order mode of “umbrella” oscillation of the saddle-resonator. As an alternative, the electric motor in FIG. 1 can be excited with a voltage at frequency νₘ⁰ formed at the output of the generator 11 such that the excitation of the piezoelement is at the natural zero-order radial mode of oscillation. However, if the natural zero-order radial mode of oscillation is selected, the amplitude of oscillation in this mode should be high enough to excite a corresponding flexural type of saddle-resonator oscillation.

A resonant match takes place when the natural frequencies of the zero order radial mode of oscillation of the piezoelement 9 and of the zero order mode of “umbrella” vibration of the annular saddle-resonator 4, 5 coincide. When the system is designed this way, the excitation of the vibrations in the annular saddle-resonators 4, 5 is the most efficient. Note that if these two frequencies do not coincide, there are two possible alternatives. A first alternative involves exciting the piezoelement 9 on its natural frequency. Because the excitation profile has a certain width, some of the energy on the wings of this excitation profile will be transferred resonantly to the saddle resonators 4, 5. The latter will be excited but the process will be inefficient. An alternative is to excite the piezoelement 9 on the natural frequency of the saddle-resonators 4, 5. In that case, the same result will occur for the reasons described above. In either case, inefficient excitation will result.

In the first embodiment of the electric motor shown in FIG. 1, the natural frequencies of the saddle-resonators 4, 5 coincide, and therefore they are excited from the common source of primary oscillation, namely the piezoelement 9. While this approach has certain advantages, the design also applies strict requirements to coincidence of the geometrical parameters of the saddle-resonators 4, 5, their identical conjugation with the piezoelement 9, and so forth. In some instances, these requirements could be too restrictive, e.g. in minimization of the device dimensions. Hence, a second embodiment of the electric motor with independent excitation of each saddle-resonator 4, 5 is disclosed below.

Referring now to FIG. 2, there is shown a second embodiment of the electric motor. The electric motor in FIG. 2 comprises an axle 1 on which are centered and fixed the upper 2 and lower 3 spherical trunnions. The trunnions 2, 3 contact along a similar spherical surface (shaped as a spherical ring) with the respective upper 4 and lower 5 annular saddle-resonators situated intermediate the trunnions 2 and 3. Piezoelements 9, 10 are polarized normally to the planar end surfaces, and electrodes of the piezoelements 9, 10 are formed on these surfaces. The piezoelements 9, 10 are secured on the housing 6 which also supports the stator winding 7, while the rotor winding 8 is mounted on the axle 1. The axial play in the system amounts from several to tens of microns. In this embodiment of the motor a second generator 12 is added for excitation of the second piezoelement 10.

The electric motor illustrated in FIG. 2 operates as follows. Sine wave excitation voltages are supplied by the two independent generators 11 and 12, at frequencies νₙ₍₄₎⁰,νₙ₍₅₎⁰ corresponding to the zero-order modes of the “umbrella” oscillations of the saddle-resonators 4 and 5. The excitation voltages are fed, respectively, to the piezoelements 9, 10 where, due to inverse piezoelectric effect, oscillation mode d₃₁ is induced in each piezoelement 9, 10. In a d₃₁ oscillation mode, the vector of primary radial oscillation of each piezoelement 9, 10 is directed along the planar end surface of the piezoelement 9, 10, which causes periodic deformation of the piezoelement 9, 10. Due to the rigid connection between the piezoelements 9, 10 and the associated saddle-resonators 4, 5, this deformation is transferred from each piezoelement 9, 10 to its associated saddle-resonator 4, 5. Consequently, a standing wave with strong bending deformation (due to the varying rigidity along the height of the resonator ring) is established in the each of the saddle-resonators 4, 5. The standing wave is responsible for the ultrasonic suspension of the rotor.

As an alternative to a d₃₁ oscillation mode, a radial oscillation can be excited in the piezoelements 9, 10. In this case, voltages at frequencies νₘ₍₉₎⁰,νₘ₍₁₀₎⁰ are generated at the output of the two auxiliary independent generators 11, 12, and standing waves with strong bending deformations are established in the saddle-resonators 4, 5, yielding ultrasonic suspension.

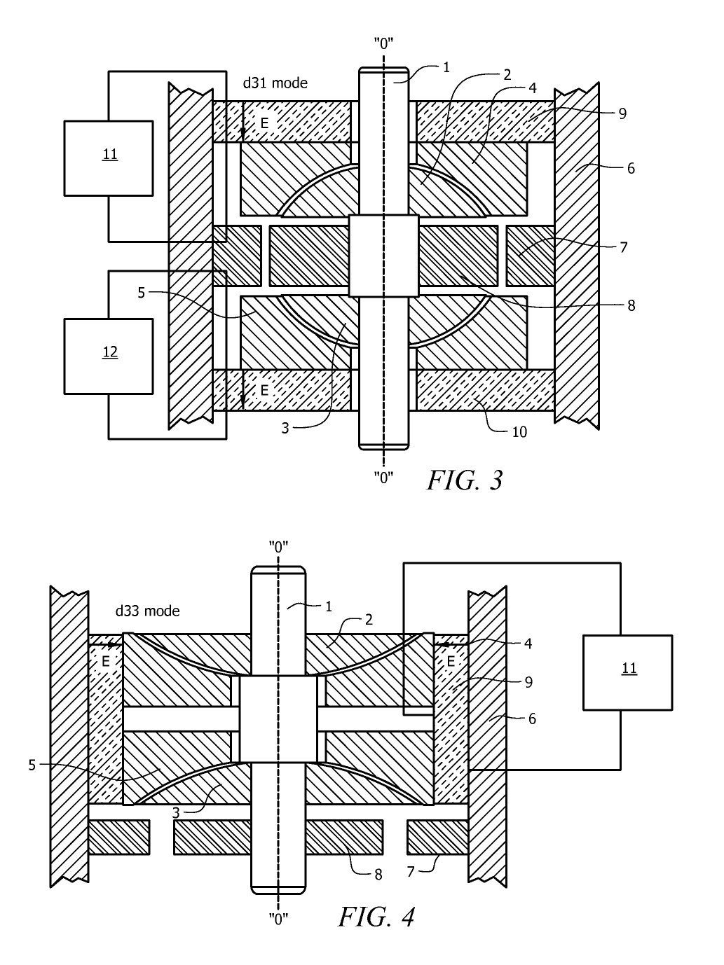

A third embodiment of the electric motor with internally-situated trunnions 2, 3 is disclosed in FIG. 3. The internally-situated trunnions 2, 3 advantageously provide enhanced rigidity. This arrangement also allows expanding the functionality of the electric motor. For instance, when the spherical centers of the upper and lower trunnions 2, 3 coincide, a design of the electric motor with a floating shaft is implemented. More particularly, in the design shown in FIG. 3 (and in FIG. 6) the trunnion can slide (rock) on the cradle (when their spherical centers coincide) simultaneously. With the remaining designs described herein the rocking of the axis is restricted insofar as they allow only rotational movement.

The third embodiment of the electric motor, FIG. 3, comprises an axle 1 on which are centered and fixed the upper 2 and lower 3 spherical trunnions. The trunnions 2, 3 are in close proximity to the respective upper 4 and lower 5 annular saddle-resonators, along a spherical surface (shaped as a spherical ring), with the trunnions 2, 3 situated between the saddle-resonators 4, 5. The saddle-resonators 4, 5 are centered in a similar manner with respect to the trunnions 2, 3, and are fixed on the annular piezoelements 9, 10 along their planar end surfaces, with the piezoelements 9, 10 situated above and under the associated saddle-resonators 4, 5. The piezoelements 9, 10 are polarized normally to the planar end surfaces, and the electrodes of the piezoelements 9, 10 are formed on these surfaces. The piezoelements 9, 10 are secured on the housing 6 which also supports stator winding 7, while the rotor winding 8 is mounted on the axle 1. The axial play in the system amounts to several to tens of microns.

The electric motor illustrated in FIG. 3 operates similarly to the motor illustrated in FIGS. 1 and 2.

The first, second and third embodiments of the electric motor utilize saddle-resonators that are fixed on the piezoelement 9, 10 along a planar end surface. In each of these embodiments, the vector of primary oscillation of the piezoelement 9, 10 is directed along this surface, i.e. the d₃₁ primary oscillation mode is excited in the piezoelement 9, 10. However, in some cases (for the sake of efficiency) it would be advisable to design the bearing supports of the electric motor so that the saddle-resonators 4, 5 are secured on the piezoelements 9, 10 along a cylindrical surface, and the vector of primary oscillation of the piezoelement 9, 10 would be directed normally to this surface. Therefore, the fourth, fifth and sixth embodiments of the electric motor discussed below in relation to FIGS. 4, 5 and 6, have this particular design of the bearing supports.

Referring now to FIG. 4, a fourth embodiment of the electric motor is disclosed. The electric motor in FIG. 4 comprises axle 1 on which are centered and fixed the upper 2 and lower 3 spherical trunnions 2, 3. The trunnions 2, 3 are in close proximity, along spherical surfaces (shaped as a spherical rings), with the respective upper 4 and lower 5 annular saddle-resonators situated intermediate the trunnions. The saddle-resonators 4, 5 are similarly centered with respect to the trunnions 2, 3, and are mounted on the annular piezoelement 9 so that their cylindrical surfaces are secured to the inner cylindrical surface of the piezoelement 9. The piezoelement 9 is polarized normally to the planar end surfaces, i.e. radially, and electrodes of the piezoelement are formed on the inner and outer radial surfaces as shown in FIG. 4. The piezoelement 9 is secured on the housing 6 which also supports stator winding 7, while the rotor winding 8 is mounted on the axle 1. The axial play in the system amounts from several to tens of microns. The piezoelement 9 is connected to the generator 11.

The electric motor illustrated in FIG. 4 operates similarly to the motor illustrated in FIG. 1, except that the vector of primary oscillation of the piezoelement 9 is directed normally to the cylindrical surface of the saddle-resonators 4, 5, and that a d₃₃ primary mode of oscillation is excited in the piezoelement 9. This results in the formation of “umbrella” oscillation, which has a greater amplitude of excitation at both, frequency νₙ⁰ and at frequency νₘ⁰, as compared to the embodiment of the electric motor illustrated in FIG. 1. In this regard it will be appreciated that the motor in FIG. 4 has a similar design to the motor in FIG. 1, but uses a different excitation and polarization of the piezoelement 9 to achieve greater amplitude of oscillation.

It is assumed in the fourth embodiment of the electric motor that the natural frequencies of the saddle-resonator 4 and 5 are the same, so that they are excited from the common source of primary oscillations—the piezoelement 9. However, this arrangement may be difficult to implement in some technologies, as has already been mentioned. Hence, a fifth embodiment of the electric motor is suggested with independent excitation of each saddle-resonator.

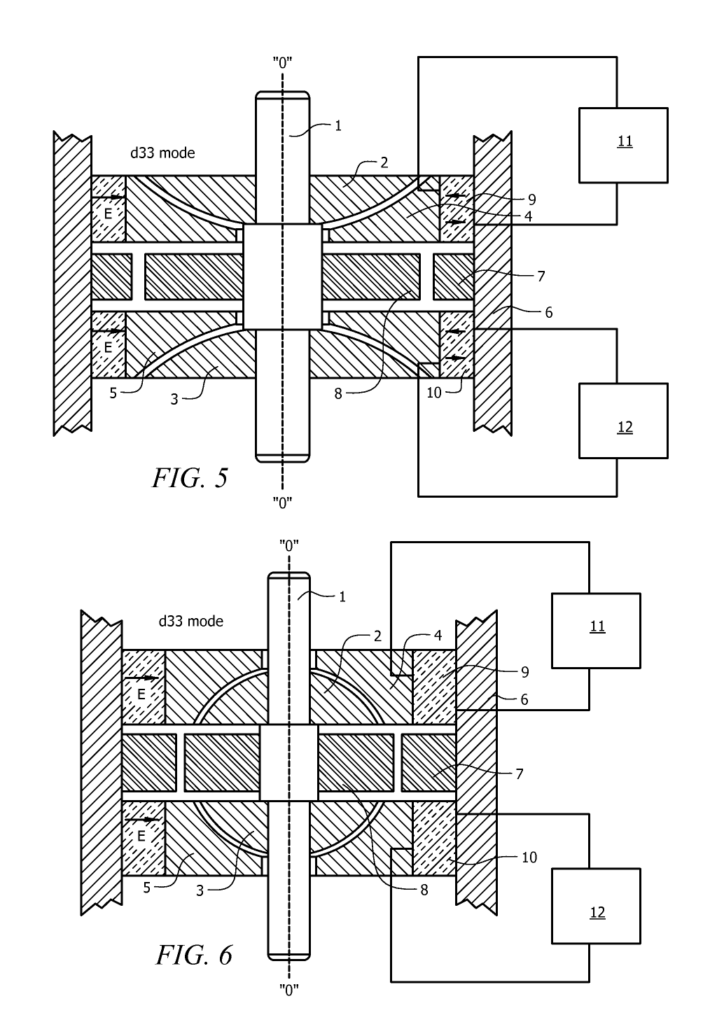

Referring now to FIG. 5, a fifth embodiment of the electric motor is disclosed. The embodiment of the invention in FIG. 5 comprises an axle 1 on which are centered and fixed the upper 2 and lower 3 spherical trunnions. The trunnions are in close proximity, along a similar spherical surface (shaped as a spherical ring), with the respective upper 4 and lower 5 annular saddle-resonators situated intermediate the trunnions 2, 3. The saddle-resonators 4, 5 are similarly centered with respect to the trunnions 2,3, and are mounted on the upper 9 and lower 10 annular piezoelements so that their cylindrical surfaces are fast with the inner cylindrical surface of the associated piezoelement 9, 10. The piezoelements 9, 10 are polarized normally with respect to the cylindrical surfaces, and electrodes of the piezoelements 9, 10 are formed on these surfaces. The piezoelements 9, 10 are secured on the housing 6 which also supports stator winding 7, while rotor winding 8 is mounted on the axle. The axial play in the system amounts from several to tens of microns.

The electric motor illustrated in FIG. 5 operates similarly to the motor illustrated in FIG. 2, except the vector of primary oscillation of the piezoelements 9, 10 is directed normally to the cylindrical surface of the saddle, and a d₃₃ primary mode of oscillation is excited in the piezoelements 9, 10.

Similar to the third embodiment of the electric motor, the sixth embodiment disclosed herein allows to enhance radial rigidity (over that of the fourth and fifth embodiments) and to expand the functionality of the motor. The sixth embodiment of the electric motor shown in FIG. 6, comprises an axle 1 on which are centered and fixed the upper 2 and lower 3 spherical trunnions. The trunnions 2, 3 are in close proximity, along a similar spherical surface (shaped as a spherical ring), with the respective upper 4 and lower 5 annular saddle-resonators, with the trunnions 2, 3 situated intermediate the saddle-resonators 4, 5. The saddle-resonators 4, 5 are similarly centered with respect to the trunnions 2, 3, and are mounted on the upper 9 and lower 10 annular piezoelements so that their cylindrical surfaces are fast with the inner cylindrical surface of the associated piezoelement 9, 10. The piezoelements 9, 10 are polarized normally to their cylindrical surfaces, and electrodes of the piezoelements 9, 10 are formed on these surfaces. The piezoelements 9, 10 are secured on the housing 6 which also supports stator winding 7, while rotor winding 8 is mounted on the axle 1. The axial play in the system amounts from several to tens of microns. The electric motor illustrated in FIG. 6 operates similarly to the motor of the fifth embodiment illustrated in FIG. 5.

The implementation of the disclosed embodiments allows obtaining electric motors based on ultrasonic non-contact bearings with technical service life as long as tens of years, load-carrying capacity of 0.1 to 1.0 kg and shaft spatial stability of a few microns. The motors described herein have numerous advantages including: virtual elimination of vibration and noise in such motors, minimization of drag torque, the absence of parasitic angular moments and the shaft self-centering property (resulting in self-balancing) due to the nonlinear elasticity of the bearing supports. Note that these properties allow the motors to accelerate to high angular speeds (as high as tens of thousands of rpm) and thus increase their usage and applicability to a higher, qualitatively new level.

We claim:

1. An electric motor or generator, comprising:
a housing, a rotor, and a stator rigidly attached to the housing;
a first piezoelectric element rigidly attached to the housing;
a first saddle having a concave surface and rigidly attached to the first piezoelectric element;
a first trunnion rigidly attached to the rotor, the first trunnion having a concave surface that is a conjugate of the concave surface of the first saddle and is spaced apart from the concave surface of the first saddle by a gap; and
wherein the first piezoelectric element, the first saddle and the first trunnion form a bearing system configured to suspend the rotor for rotation in relation to the stator.

2. The electric motor or generator of claim 1, wherein:
the first piezoelectric element is operative to undergo oscillatory deformation when subjected to an electric potential; and
the first saddle is operative to undergo oscillatory deformation in response to the oscillatory deformation of the first piezoelectric element, wherein the first saddle is configured to generate with the oscillatory deformation a first field of acoustical energy in a gaseous medium located within the gap between the concave surfaces of the first saddle and the first trunnion.

3. The electric motor or generator of claim 1, wherein a natural frequency of a zero-order mode of umbrella oscillation of the first saddle substantially coincides with a natural frequency of a zero-order radial mode of oscillation of the first piezoelectric element.

4. The electric motor or generator of claim 1, further comprising a generator operative to excite the first piezoelectric element.

5. The electric motor or generator of claim 4, wherein the generator is operative to excite the first piezoelectric element at a frequency corresponding to a zero-order mode of umbrella oscillation of the first saddle.

6. The electric motor or generator of claim 4, wherein the generator is operative to excite the first piezoelectric element at a natural zero-order radial mode of oscillation.

7. The electric motor or generator of claim 1, wherein the first saddle has a Q factor of approximately 1,000 to approximately 10,000.

8. The electric motor or generator of claim 1, wherein an axial play between the first saddle and the first trunnion is approximately 1 μm to approximately 40 μm.

9. The electric motor or generator of claim 1, wherein the concave surface of the first saddle is spaced apart from the concave surface of the first trunnion by a gap of approximately 0.5 μm to approximately 20 μm.

10. The electric motor or generator of claim 2, wherein:
the first saddle is configured to direct the field of acoustical energy toward a center of curvature of the concave surface of the first trunnion and to shape the field of acoustical energy as a spherical wave;
the concave surface of the first trunnion is operative to reflect the wave so that a standing acoustical wave is formed in a gap between the concave surface of the first trunnion and the concave surface of the first saddle; and
wherein the first trunnion and the first saddle are configured to generate radiation acoustic pressure resulting from the standing wave and acting on the concave surface of the first trunnion and the concave surface of the first saddle, and to suspend the rotor at least in part for rotation in relation to the stator when the standing wave is present.

11. The electric motor or generator of claim 1, wherein the first saddle and the first trunnion comprise glass.

12. The electric motor or generator of claim 2, further comprising:
a second saddle having a concave surface and being rigidly attached to the first piezoelectric element so that the second saddle is operative to undergo oscillatory deformation in response to the oscillatory deformation of the second piezoelectric element; and
a second trunnion rigidly attached to the rotor and having a concave surface that substantially matches in size and shape the concave surface of the second saddle and is spaced apart from the concave surface of the second saddle by a gap, wherein the second saddle is configured to generate with the oscillatory deformation a second field of acoustical energy in a gaseous medium located within the gap between the concave surfaces of the second saddle and the second trunnion.

13. The electric motor or generator of claim 12, wherein:
the first and second saddles are rigidly attached to respective first and second substantially planar surfaces of the first piezoelectric element so that the first piezoelectric element is located intermediate the first and second saddles, the first and second surfaces of the first piezoelectric element extending in a direction substantially perpendicular to an axis of rotation of the rotor;
the first piezoelectric element is polarized in a direction substantially perpendicular to the first and second surfaces of the first piezoelectric element; and
the second saddle is located intermediate the first saddle and the rotor.

14. The electric motor or generator of claim 12, wherein:
substantially cylindrical outer surfaces of the first and second saddles are rigidly attached to a substantially cylindrical inner surface of the first piezoelectric element;
the first piezoelectric element is radially polarized; and
the second saddle is located intermediate the first saddle and the rotor.

15. The electric motor or generator of claim 2, further comprising:
a second piezoelectric element rigidly attached to the housing and operative to undergo oscillatory deformation when subjected to an electric potential;
a second saddle having a concave surface and being rigidly attached to the second piezoelectric element so that the second saddle is operative to undergo oscillatory deformation in response to the oscillatory deformation of the second piezoelectric element; and
a second trunnion rigidly attached to the rotor and having a concave surface that substantially matches in size and shape the concave surface of the second saddle and is spaced apart from the concave surface of the second saddle by a gap, wherein the second saddle is configured to generate with the oscillatory deformation a second field of acoustical energy in a gaseous medium located within the gap between the concave surfaces of the second saddle and the second trunnion.

16. The electric motor or generator of claim 15, wherein:
the first saddle is rigidly attached to a substantially planar surface of the first piezoelectric element that extends substantially perpendicular to a direction of rotation of the rotor;
the second saddle is rigidly attached a substantially planar surface of the second piezoelectric element that extends substantially perpendicular to a direction of rotation of the rotor;
the first piezoelectric element is polarized in a direction substantially perpendicular to the substantially planar surface of the piezoelectric element; and
the second piezoelectric element is polarized in a direction substantially perpendicular to the substantially planar surface of the second piezoelectric element.

17. The electric motor or generator of claim 16, wherein the first piezoelectric element is positioned intermediate the rotor and the first saddle, and the second piezoelectric element is positioned intermediate the rotor and the second saddle.

18. The electric motor or generator of claim 16, wherein the first saddle is positioned intermediate the rotor and the first piezoelectric element, and the second saddle is positioned intermediate the rotor and the second piezoelectric element.

19. The electric motor or generator of claim 15, wherein:
a substantially cylindrical outer surface of the first saddle is rigidly attached to a substantially cylindrical inner surface of the first piezoelectric element;
a substantially cylindrical outer surface of the second saddle is rigidly attached to a substantially cylindrical inner surface of the second piezoelectric element; and
the first and second piezoelectric elements are radially polarized.

20. The electric motor or generator of claim 18, wherein the first saddle is positioned intermediate the rotor and the first trunnion, and the second saddle element is positioned intermediate the rotor and the second trunnion.

21. The electric motor or generator of claim 18, wherein the first trunnion is positioned intermediate the rotor and the first saddle, and the second trunnion is positioned intermediate the rotor and the second saddle.

22. A bearing system for suspending a rotating component in relation to a non-rotating component, comprising:
a first piezoelectric element rigidly attached to the non-rotating component and operative to undergo oscillatory deformation when subjected to an electric potential;
a first saddle having a concave surface and rigidly attached to the first piezoelectric element, the first saddle operative to undergo oscillatory deformation in response to the oscillatory deformation of the first piezoelectric element, and the oscillatory deformation of the first saddle configured to generate a first field of acoustical energy in a gaseous medium adjacent to the concave surface; and
a first trunnion rigidly attached to the rotating component, the first trunnion having a concave surface that is a conjugate of the concave surface of the first saddle and spaced apart from the concave surface of the first saddle by the gaseous medium, wherein the concave surface of the first trunnion is configured to be subjected to the first field of acoustical energy in response to the oscillatory deformation of the first saddle.

23. A method for suspending a rotating component in relation to a non-rotating component, comprising:
providing a bearing system comprising a piezoelectric element rigidly attached to the non-rotating component; a saddle having a concave surface and rigidly attached to the piezoelectric element; and a trunnion rigidly attached to the rotating component, the trunnion having a surface that is a conjugate of the surface of the saddle and is spaced apart from the surface of the saddle by a gap; and
applying a voltage potential to the piezoelectric element sufficient to excite the piezoelectric element so that the piezoelectric element induces oscillatory deformation in the saddle, the oscillatory deformation generating a field of acoustic energy in a gaseous medium within the gap, the field of acoustic energy interacting with the conjugate surfaces of the trunnion and the saddle to produce a standing wave that supports the rotating component at least in part in relation to the non-rotating component.
